(19) United States
(12) Patent Application Publication
(10) Pub. No.: US 2019/0295042 A1
(43) Pub. Date: Sep. 26, 2019

(54) SETTING AND UPDATING ALARMS BASED ON DATA ITEMS

(71) Applicant: Microsoft Technology Licensing, LLC, Redmond, WA (US)

(72) Inventor: Richard John LAZAR, JR., Seattle, WA (US)

(21) Appl. No.: 15/935,772

(22) Filed: Mar. 26, 2018

(51) Int. Cl. G06Q 10/10; G06N 99/00

(52) U.S. Cl. CPC G06Q 10/1095; G06Q 50/14; G06N 99/005

(57) ABSTRACT

When a user creates an alarm in a calendar, they can associate the alarm with rules that control when or if the alarm is triggered. These rules operate on data items that can include data from a variety of external and internal sources. The data items can include traffic conditions, events in a calendar of one or more users, asset prices, user actions, and user locations. When the values associated with the data items change, the rules associated with the alarm are used to determine whether the time associated with the alarm may be adjusted or whether the alarm may be removed from the calendar. The rules and data items associated with the alarm may be defined by a user using a programming language or syntax, or may be inferred from user input using natural language processing.

### BACKGROUND

Users are able to create alarms using most calendar applications. Typically, a user creates an alarm by specifying a future date and time and providing text or other data that indicates to the user a desired action or result. When the current date and time is the same as the date and time associated with the alarm, the calendar application can present the associated text or other data to the user at an associated computing device using a notification. Examples of uses for alarms include reminding the user of upcoming meetings, events, and deadlines.

While alarms are useful, the dates and times associated with the alarms are typically static even when the purpose or reason for the alarm is dependent on another event or data item. For example, a user may desire to create an alarm to remind them to prepare one hour before a meeting scheduled at 10 am. Accordingly, the user would use their calendar application to create an alarm at 9 am that includes the instruction “Prepare for 10 am meeting.” Because the time associated with the meeting is static, the alarm will be triggered at 9 am by the calendar application even if the 10 am meeting is later canceled or rescheduled.

As another example, a user may create an alarm in their calendar to wake them up at 5 am for a flight scheduled from New York to Seattle at 10 am. Overnight the flight may become canceled or significantly delayed. However, because the alarm is static, the user is woken up at 5 am even though it is not necessary given the change in the status of the flight.

### SUMMARY

When a user creates an alarm in a calendar, they can associate the alarm with rules that control when or if the alarm is triggered. These rules operate on data items that can include data from a variety of external and internal sources. The data items can include, for example, traffic conditions, events in a calendar of one or more users, asset prices, user actions, and user locations. When the values associated with the data items change, the rules associated with the alarm are used to determine if the time associated with the alarm may be adjusted or if the alarm may be removed from the calendar. The rules and data items associated with the alarm may be defined by a user using a programming language or syntax, or may be inferred from user input using natural language processing.

In an implementation, a method for managing alarms is provided. The method includes: receiving an indication of an alarm for a first user at a computing device, wherein the alarm is associated with a first time and one or more rules, and each rule is associated with one or more data items; adding the alarm to a calendar associated with the first user at the associated first time by the computing device; receiving a change to at least one data item associated with the one or more of the rules by the computing device; based on the received change and the rule associated with the at least one data item, generating a second time for the alarm by the computing device; and updating the alarm in the calendar to the second time by the computing device.

In an implementation, a method for creating alarms is provided. The method may include: receiving a request for an alarm from a first user by a cloud computing environment; generating one or more rules associated with the alarm from the request by the cloud computing environment, wherein each rule is associated with a data item of one or more data items, and at least one data item of the one or more data items is associated with a second user; retrieving the one or more data items by the cloud computing environment; based on the retrieved one or more data items and the one or more rules, generating a first time associated with the alarm by the cloud computing environment; adding the alarm to a calendar associated with the first user at the associated first time by the cloud computing environment; receiving a change to the at least one data item by the cloud computing environment; based on the change to the at least one data item and the rule associated with the at least one data item, generating a second time associated with the alarm by the cloud computing environment; and updating the received alarm in the calendar associated with the first user to the generated second time by the cloud computing environment.

In an implementation, a method for creating an alarm is provided. The method includes: receiving a request for an alarm from a first user by a computing device, wherein the alarm is associated with an action and a time; generating one or more rules associated with the alarm from the request by the computing device, wherein each rule of the one or more rules is associated with a data item; retrieving the data items associated with the one or more rules by the computing device; based on the retrieved data items, establishing that each rule of the plurality of rules has been satisfied; and in response to establishing that each rule of the plurality of rules has been satisfied, setting the alarm to perform the associated action at the associated time.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example embodiments; however, the embodiments are not limited to the specific methods and instrumentalities disclosed. In the drawings:

FIG. 1 is an illustration of an exemplary environment for creating and managing alarms;

FIG. 2 is an illustration of an implementation of an exemplary alarm engine;

FIGS. 3-7 are illustrations of an example user interface for creating and managing alarms;

FIG. 8 is an operational flow of an implementation of a method for creating an alarm based on a user request and for dynamically setting the created alarm based on user defined rules and data items;

FIG. 9 is an operational flow of an implementation of a method for receiving an alarm and for updating the received alarm in response to changes to one or more data items;

FIG. 10 is an operational flow of an implementation of a method for generating an alarm and for updating the generated alarm in response to changes to one or more data items; and

FIG. 11 shows an exemplary computing environment in which example embodiments and aspects may be implemented.

### DETAILED DESCRIPTION

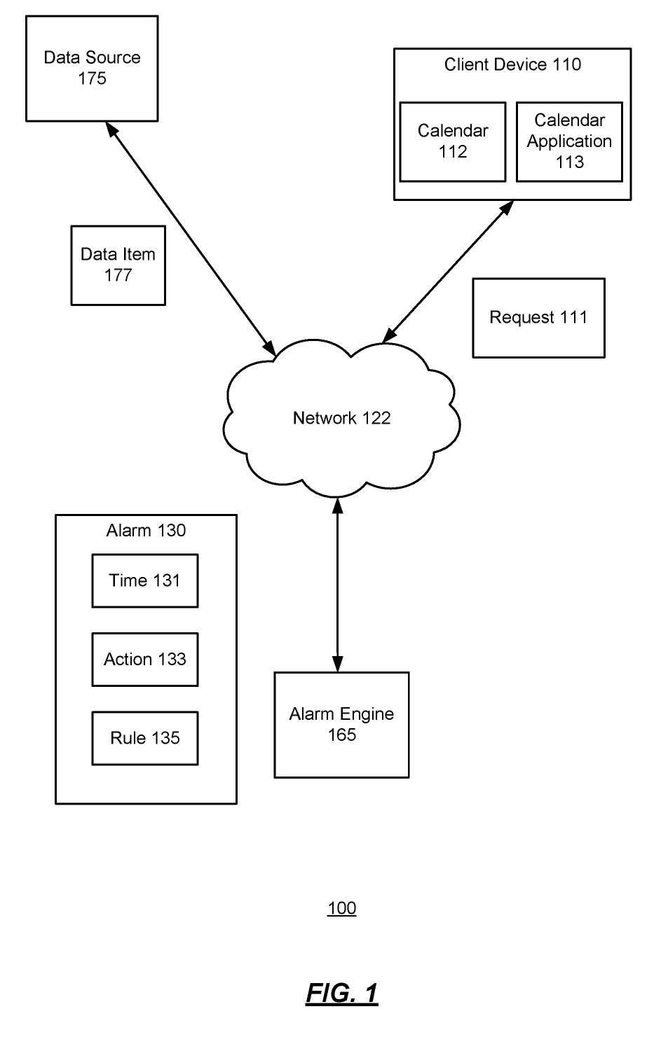

FIG. 1 is an illustration of an exemplary environment for creating and managing alarms. The environment 100 may include an alarm engine 165, a data source 175, and one or more client devices 110 in communication through a network 122. The network 122 may be a variety of network types including the public switched telephone network (PSTN), a cellular telephone network, and a packet switched network (e.g., the Internet). Although only one client device 110, one alarm engine 165, and one data source 175 are shown in FIG. 1, there is no limit to the number of client devices 110, alarm engines 165, and data sources 175 that may be supported.

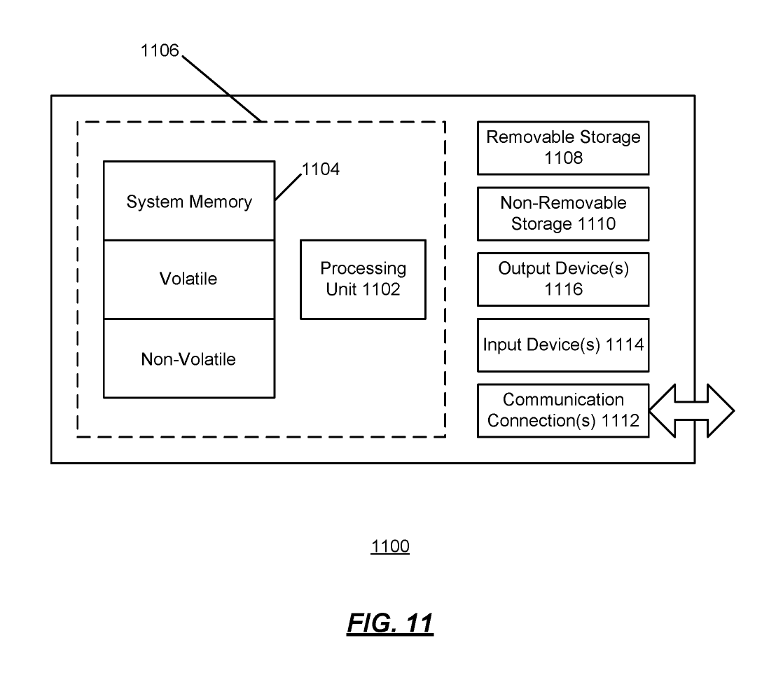

The client device 110 and the alarm engine 165 may be implemented using a variety of computing devices such as smartphones, desktop computers, laptop computers, tablets, set top boxes, vehicle navigation systems, and videogame consoles. Other types of computing devices may be supported. A suitable computing device is illustrated in FIG. 11 as the computing device 1100.

The client device 110 may execute one or more calendar applications 113. A calendar application 113 may allow a user to maintain one or more calendars 112. A calendar 112 may be a type of file or data structure that allows a user to organize and plan their time. A user may use a calendar 112 to keep track of events such as meetings or deadlines. Typically, a user associates events with dates and times in their calendar 112 using the calendar application 113. The user can use the calendar application 113 to view their events, and the calendar application 113 can notify the user when a date or time associated with an event is approaching. Modern calendar applications 113 may also allow users to coordinate their calendars 112. For example, a first user may use the calendar application 113 to schedule an event with a second user. The calendar application 113 may add the scheduled event to the calendar 112 associated with the first user and the calendar 112 associated with the second user. Alternatively there may be multiple calendar applications 113 and the calendar application 113 associated with the first user may add the scheduled event to the calendar 112 associated with the first user and the calendar application 113 associated with the second user may add the scheduled event to the calendar 112 associated with the second user.

More specifically, calendar applications 113 may allow users to create and schedule one or more alarms 130. An alarm 130 may be associated with a time 131 when the alarm 130 is set to occur, and an action 133 that is to be performed by the calendar application 113 at the set time 131. As used herein, the term “time” may include one or both of a date and a time-of-day. The time 131 associated with an alarm 130 may be a single time (e.g., Nov. 28, 2017 at 10 am) or may be a recurring time (e.g., every day at 8 am or every other Wednesday at 3 pm). The action 133 associated with an alarm 130 may include generating and/or displaying a notification on one or more client devices 110 associated with a user or multiple users, sending a text message or email, opening or executing one or more applications, etc.

Users may use alarms 130 for a variety of purposes. For example, users may schedule an alarm 130 to wake them up every morning at a particular time, to remind them to prepare for an upcoming meeting, or to remind them of important dates such as birthdays and anniversaries.

As described above, one drawback associated with alarms in current calendar applications is that the times associated with alarms are generally static, even though the time of the alarm may be related to, or dependent on, another event. For example, a user may create an alarm to remind them in the morning to pack sneakers for a running activity with a friend that has been scheduled in their calendar. At some point, the friend may cancel the running activity, but the alarm remains in the calendar even though the related running activity is no longer in the calendar. Accordingly, the calendar application will remind the user to pack sneakers in the morning for a running activity that is no longer scheduled.

To solve the problems associated with static alarms, the environment 100 may include one or more alarm engines 165. The alarm engine 165 may create alarms 130 that are associated with one or more rules 135 that control when (or if) the associated alarms 130 are scheduled. Depending on the implementation, the alarm engine 165 may be a cloud-based service that may be executed by one or more computing devices that are separate from the client device 110. Alternatively, the alarm engine 165 may be executed by the client device 110, and may be integrated into the calendar application 113. Note that while the alarm engine 165 is described herein with respect to calendars 112 and calendar applications 113, the alarm engine 165 and alarms 130 are not limited to calendars 112 and calendar applications 113. For example, the alarm engine 165 may be incorporated into any type of application that allows users to create or schedule alarms.

Each of the rules 135 associated with an alarm 130 may depend on one or more external data items 177 (e.g., information from external data sources 175 that can affect the alarm 130). The data items 177 may include arbitrary values that can be read or received by a computing device. The data items 177 may include the price of an asset in a market, the status of a flight or public transportation, scores in a professional sporting event, current and historical traffic conditions, current and historical user locations, current and historical weather conditions, television or movie schedules, school or business opening or closing times, etc. The data items 177 provided by the data sources 175 may be public information collected from the Internet or other data services. The data items 177 may also include private information such as the locations of other users who opt-in to having their locations known and tracked.

Some of the data items 177 may be provided to the alarm engine 165 by the client device 110 on behalf of a user. These data items 177 may include events on the calendar 112 associated with the user, the current location of the user, financial information associated with the user, biometric data associated with the user, the status of various home automation and smart devices associated with the user (e.g., temperature at home, alarm status, door and window open or closed status, and the statuses of lights and appliances), data associated with other applications executing on the client device 110 of the user, and the status of the client device 110 itself, for example. Other types of data may be supported.

The various data items 177 and information collected about each user with respect to each of the rules 135 may be personal and private. Accordingly, to protect the privacy of each user, any data items 177 collected by the alarm engine 165 may be encrypted. Moreover, before any data items 177 are collected and used by the alarm engine 165, each user may be asked to opt-in or otherwise consent to the collection and use of such data items 177.

In some implementations, a user may create an alarm 130 by providing a request 111 to their calendar application 113. The calendar application 113 may provide the request 111 to the alarm engine 165 for processing. The alarm engine 165 may process the request 111 to determine the rules 135 and data items 177 associated with the desired alarm 130. In addition, the alarm engine 165 may determine the desired action 133 and time 131 for the alarm 130 based on the determined rules 135 and data items 177.

The user may provide the request 111 using natural language. For example, the user may type or speak a request 111 for an alarm 130 such as “Remind me to pack four hours before my train leaves on Tuesday.” The alarm engine 165 may process the request 111 using a machine learning model. The machine learning model may accept as an input natural language from the user and generate as an output commands in a syntax understood by the alarm engine 165. The machine learning model may be trained based on data about the user (e.g., user history or user preferences) and may consider information about the user such as the current location of the user and information from the calendar 112 associated with the user.

The alarm engine 165 may determine from the user's calendar 112 that by “my train” and “Tuesday” the user is referring to train #2134 from New York to Washington D.C. at 2 pm on the next upcoming Tuesday. The alarm engine 165 may create a rule 135 to notify the user four hours before the 2 pm train time. One data item 177 considered by the alarm engine 165 is the scheduled departure time of the train from New York for that day. This data item 177 may be provided by a data source 175 associated with transportation schedules. The alarm engine 165 may place a corresponding alarm 130 in the calendar 112 associated with the user at a time 131 of 10 am (i.e., four hours before the scheduled 2 pm departure time). The alarm 130 may notify the user to pack. In one configuration, the alarm 130 may audibly tell the user to begin packing. In another configuration, the alarm 130 may send a text notification to the client device 110 indicating that the user needs to begin packing.

To provide for dynamic alarms 130, the alarm engine 165 may continuously, or at scheduled intervals, reevaluate the rules 135 associated with an alarm 130 to determine whether one or more of the data items 177 associated with the rules 135 have changed. Based on the changed data items 177 and the associated rules 135, the alarm engine 165 may determine that the time 131 associated with an alarm 130 has changed, or that the alarm 130 has been removed from the calendar 112.

The alarm engine 165 may monitor the data item 177 associated with the departure time of train #2134 and may determine that the train has been delayed from 2 pm to 4 pm. Based on the change in the data item 177 associated with the train departure time, the alarm engine 165 may use the rule 135 associated with the alarm 130 to update the alarm 130 in the calendar 112 associated with the user.

The rules 135 described herein can be used to create a variety of dynamic alarms 130 that depend on a variety of data items 177 and combinations of data items 177. For example, a user could create an alarm 130 with a rule 135 to remind them to prepare for an upcoming meeting. If the meeting is rescheduled or canceled, the alarm 130 would automatically be rescheduled or canceled based on the rule 135.

The user may create dynamic alarms 130 that are based on user actions with respect to calendar 112 events. For example, a user may create an alarm 130 to remind them of the scheduled calendar 112 event of picking up their child from school only if their partner is not already picking up the child. If the partner declines the event to indicate that they cannot pick up the child, the alarm engine 165 would ensure that the alarm 130 is added to the calendar 112 associated with the user. If the partner accepts the event, the alarm 130 would be removed from the calendar 112 of the user.

As another example, the user could create an alarm 130 with a rule 135 to remind them to start dinner an hour before their partner is expected to arrive at home. The alarm engine 165 would retrieve data items 177 such as the current location of the partner and real-time traffic conditions associated with a route between the current location and the home. The alarm engine 165 would estimate when the partner is an hour from home based on the data items 177, and would update the time 131 associated with the alarm 130 so that the calendar application 113 generates a notification when the partner is an hour away according to the rule 135 associated with the alarm 130. As the current location of the partner and/or the traffic conditions change, the alarm engine 165 would continue to update the time 131 associated with the alarm 130.

Other types of alarms 130 that could be created include alarms that alert the user based on data items 177 such as weather or traffic conditions. For example, the user may create an alarm 130 that instructs them to wake up at 6 am when it is snowing, or when poor traffic conditions are detected, but otherwise at 7 am. Other types of alarms 130 could be based on data items 177 such as the closing price of a stock or an asset, the balance of a savings account associated with the user, or the receipt of an email or a text from an employer or other identified user. There is no limit to the variety of data items 177 and rules 135 that may be used to create alarms 130 by the alarm engine 165.

The dynamic alarms 130 associated with the alarm engine 165 may provide many technical advantages over the static alarms commonly associated with calendar applications. One advantage is that the user does not have to manually manage the dependencies of alarms with respect to calendar events and other data. For example, previously if a user set an alarm to wake up early for an upcoming event, the user would be awoken by the alarm at the scheduled time even if the associated event had been canceled by another user while the user was sleeping. Thus, the dynamic alarms 130 provided by the alarm engine 160 ensure that the user is no longer bothered by alarms that are not relevant and applicable.

Another advantage of the dynamic alarms 130 provided by the alarm engine 165 is that the alarms 130 can be defined using arbitrary combinations of rules 135 and data items 177. Previously, calendar applications were limited to setting notifications using criteria such as dates and time, or user location. By allowing users to create dynamic alarms 130 using different combinations of rules 135 and data items 177, the user can be unburdened of having to monitor certain conditions or data items 117 to remember to perform certain actions and can instead rely on the dynamic alarms 130.

For example, a user may take a particular train home every day from work. Because of reliability issues associated with the train, the user is forced daily to determine if the train is on time or late before the user determines when to walk from their office to the train station. This is a distraction for the user because they are forced to stop what they are doing to calculate the appropriate time to leave. Instead, the user could create a dynamic alarm 130 using the alarm engine 165 whose time 131 is automatically updated based on real-time data items 177 relating to the departure time of the train from the train station. This allows the user to be automatically informed of the optimal time to leave for the train every day without having to continuously monitor the status of the train themselves.

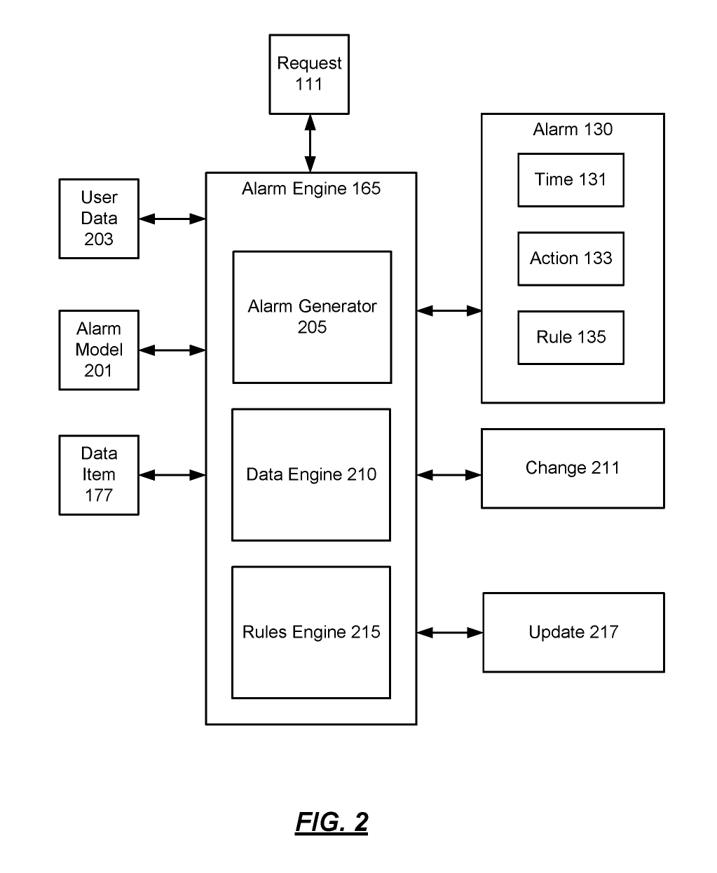

FIG. 2 is an illustration of an implementation of an exemplary alarm engine 165. The alarm engine 165 may include one or more components such as an alarm generator 205, a data engine 210, and a rules engine 215. More or fewer components may be included in the alarm engine 165. Some or all of the components of the alarm engine 165 may be implemented by one or more cloud computing environments. The cloud computing environment may be made up of multiple computing devices such as the computing device 1100 described with respect to FIG. 11. By implementing the alarm engine 165 in a cloud computing environment, a variety of client devices 110 may be provided with the features and benefits of the alarm engine 165 and may experience a high level of service due to the distributed nature and reliability of cloud computing environments.

The alarm generator 205 may receive a request 111 for an alarm 130 from the calendar application 113, and in response to the request may generate an alarm 130 corresponding to the request 111. The alarm generator 205 may generate an alarm 130 corresponding to the request 111 by processing the request 111 to determine one or more rules 135 that operate on one or more data items 177.

The alarm generator 205 may also process the request to determine a time 131 and an action 133 associated with the alarm 130. The action 133 associated with the alarm 130 may be an act that is performed by the alarm engine 165 and/or the calendar application 113 when some or all of the rules 135 associated with the alarm 130 are satisfied, and/or at the time 131 associated with the alarm 130. Example actions 133 may include sending an email or text message, displaying a notification on the client device 110 associated with the user, playing a sound on the client device 110 associated with the user, or opening an application on the client device 110 associated with the user. Generally, any action that can be performed by a computing device may be used as an action 133 for an alarm 130.

Depending on the implementation, determining the time 131 associated with an alarm 130 from the request 111 may include the alarm generator 205 retrieving one or more data items 177 associated with the determined rules 135, and processing the rules 135 using the retrieved data items 177 to determine the time 131.

For example, for an alarm 130 that includes the rule 135 that the user be alerted so that they can get to the airport forty-five minutes after an airplane flight has landed, before the alarm generator 205 can determine the time 131 for the alarm 130, the alarm generator 205 may first determine data items 177 such as when the flight is scheduled to land, the location that the user will likely be when the flight lands, and how long it will take the user to drive to the airport from their location given traffic conditions. Because the future location of the user and future traffic conditions are unknown, the alarm generator 205 may use historical location information associated with the user and historical traffic information to determine the data items 177.

For other alarms 130, the alarm generator 205 may not need to determine the time 131 using the data items 177 and the rules 135. For example, for an alarm that includes the rule 135 that the user be alerted if it is after 5 pm and their child is not home, the time 131 associated with the alarm 130 is 5 pm and does not depend on any rules 135.

In some implementations, the requests 111 may be received by the alarm generator 205 in a natural language format. In these implementations, the user may speak or type the request 111 into their associated calendar application 113 using the same grammar and structure that they would use to write or speak the request 111. The alarm generator 205 may process the request 111 to generate the associated alarm 130 using an alarm model 201 that is trained using machine learning to identify rules 135, times 131, data items 177, and actions 133 based on user speech or text. The alarm model 201 may be a global model based on information collected about a variety of users, or may be a user specific model that is trained based on information specific to the user of the client device 110.

Alternatively or additionally, the user may provide the request 111 using a specialized schema or programming language that allows the user to specify the rules 135, times 131, data items 177, and actions 133 that they would like to use for their alarm 130. In these implementations, the alarm generator 205 may provide a user interface through which the user can define one or more rules 135 for their alarm 130, and may select one or more data items 177 for the defined rules 135. Other methods for providing a request 111 or for generating an alarm 130 may be used.

After generating the alarm 130 from the request 111, the alarm generator 205 may present the generated alarm 130 to the user for approval. The alarm 130 may be displayed to the user by the calendar application 113 on the client device 110. Depending on the implementation, the alarm 130 may be displayed along with the determined rules 135, times 131, and actions 133. Where the rules 135 operate on any data items 177, information about the data items 177 may also be displayed. For example, if the alarm 130 includes rules 135 that depend on data items 177 such as traffic conditions and an event in the calendar 112 of the user, these dependencies may be indicated to the user. This may allow the user to modify the alarm 130 to no longer consider traffic conditions, or to select a different event from the calendar 112 for the alarm 130.

After presenting the alarm 130 to the user, the user may modify the proposed alarm 130, may reject the proposed alarm 130, or may accept the proposed alarm 130. If the user accepts the alarm 130, or modifies the proposed alarm 130, the alarm generator 205 may add the alarm 130 to the calendar 112 associated with the user. If the time 131 associated with the alarm 130 is known, or estimated, the alarm 130 may be added to the calendar 112 at the known or estimated time 131. Depending on the implementation, the alarm 130 may be displayed to the user in the calendar 112 using colors, icons, or other indicators that indicate to the user that the alarm 130 is dynamic and depends on one or more rules 135 and data items 177. The user may select the alarm 130 to receive more information about the one or more rules 135 and data items 177 associated with the alarm 130.

If the user rejects the alarm 130 or modifies the alarm 130, depending on the implementation, the rejected or modified alarm 130 may be used as feedback to train the alarm model 201. For example, the user may generate a natural language request 111 such as “remind me to call Stacy an hour after my meeting with Jim.” Using the alarm model 201, the alarm generator 205 may determine that the user is referring to their scheduled 2:30 pm-3:30 pm meeting with a contact named “Jim Franks” and a contact named “Stacy Smith.” The alarm generator 205 may present the user with a proposed alarm 130 to remind the user to call or otherwise contact Stacy Smith at 4:30 pm (i.e., one hour after the end of the scheduled 2:30 pm-3:30 pm meeting). After viewing the proposed alarm 130, the user may modify the alarm 130 because the user may have meant their contact named “Stacy Jones” and not “Stacy Smith”. In response, the alarm generator 205 may provide feedback to the alarm model 201 so that in the future the alarm model 201 will prefer the contact “Stacy Jones” when there is ambiguity in a request 111. Any method for updating a machine learning model may be used.

In some implementations, the alarm generator 205 may recommend one or more alarms 130 for a user based on user data 203. The user data 203 may include data collected about a user such as a location history of the user, identifiers of client devices 110 associated with the user, contacts of the user, routes traveled by the user, applications used by the user, types of transportation used by the user, etc. Depending on the implementation, no user data 203 may be collected for a user until the user opts-in or otherwise consents to the collection of such data.

The alarm generator 205 may recommend one or more alarms 130 for the user by processing the user data 203 to identify patterns of behaviors associated with the user that may be automated through a dynamic alarm 130. For example, using the user data 203 the alarm generator 205 may recognize that the user tends to leave their office at 4:50 pm to catch a scheduled 5 pm bus home. The alarm generator 205 may also determine that the bus is also frequently delayed resulting in the user having to wait. Accordingly, the alarm generator 205 may recommend an alarm 130 that notifies the user to leave their office ten minutes before the bus is scheduled to arrive that uses real-time schedule information for the bus.

In another example, the alarm generator 205 may determine that the user received an email that refers to an upcoming flight that the user is taking. Based on the user data 203, the alarm generator 205 may determine the likely location of the user and the transportation method that the user will take to the airport. The alarm generator 205 may recommend an alarm 130 that notifies the user to leave their home four hours before the flight is scheduled to depart that incorporates data items 177 such as real-time schedule information for the flight and traffic conditions.

The data engine 210 may receive data items 177 associated with rules 135 for one or more alarms 130. As described above, the data items 177 may be provided from one or more data sources 175, may be provided from one or more client devices 110, or may be provided by the one or more calendar applications 113. Other sources of data items 177 may be supported.

Examples of data items 177 that may be provided by data sources 175 may include weather conditions, traffic conditions, stock or asset data, score data relating to one or more sporting events, and public transportation related data (e.g., airplane, train, subway, and bus schedules). Depending on the implementation, the data engine 210 may continuously, or periodically, monitor the data items 177 provided by each of the various data sources 175. Alternatively, the data engine 210 may subscribe to selected data items 177 through a single data source 175 that specializes in collecting and providing data items 177 from a variety of other data sources 175.

Examples of data items 177 that may be provided by client devices 110 may include the current location of the client device 110 (or user associated with the client device 110) and identifiers of applications that are executing on the client device 110. For example, each client device 110 associated with the data engine 210 may periodically, or continuously, provide its current location to the data engine 210. The current location may be determined by a GPS, or other location determination component, associated with the client device 110.

Examples of data items 177 that may be provided by one or more calendar applications 113 may include information about events, or other entries, in the calendar application 113 associated with each user. The data items 177 may include dates and times associated with each event, the identifiers of users or contacts that may be attending, or that may be invited to, the event. For events that have already started, the data items 177 may include a time when the event started, a time when the event is scheduled to end, and attendees of the event. Other data items 177 may be included.

Depending on the implementation, for each alarm 130 associated with a user, the data engine 210 may collect the data items 177 that are used by a rule 135 associated with the alarm 130, and may provide the collected data items 177 to the rules engine 215. Alternatively, the data engine 210 may compare values of collected data items 177 with values of previously collected data items 177. If the data engine 210 determines a change 211 in the value of a data item 177, the data engine 210 may provide the determined change 211 and an identifier of the data item 177 to the rules engine 215. Alternatively, the data engine 210 may receive the changes 211 from one or more data sources 175.

The rules engine 215 may receive a change 211 to a data item 177, and in response to the change 211 may generate the time 131 associated with alarm 130. Depending on the implementation, the rules engine 215 may generate the time 131 for the alarm 130 by applying some or all of the rules 135 associated with the alarm 130 using the data items 177 associated with the change 211. If the change 211 results in a new time 131 associated with the alarm 130, the alarm engine 165 may generate an update 217 that includes the new time 131. The update 217 may be provided to the calendar application 113, and the calendar application 113 may change the time 131 for the alarm 130 in the calendar 112. In some implementations, the rules engine 215 may generate a time 131 by applying a time offset associated with a rule 135 to a time associated with the data item 177.

The time associated with the data item 177 may be the time that the data item 177 is predicted or scheduled to occur. For example, a data item 177 of an airplane flight arrival may have a time that is the expected or predicted arrival time for the airplane flight. In another example, for a data item 177 of a scheduled event in a calendar 112, the time may be when the event is scheduled in the calendar 112.

The time offset for a rule 135 may be how much before, or how much after, the alarm 130 is scheduled to be set relative to the time associated with the data item 177. For example, a rule 135 that is to remind a user one hour before the data item 177 of their partner's arrival time, may have an offset of one hour before the predicted arrival time. In another example, a rule 135 that is to remind a user to pick up their partner forty-five minutes after they arrive at the airport, may have an offset of forty-five minutes after the data item 177 of their predicted arrival time.

The rules engine 215 may generate a new time for an alarm 130 by applying the offset associated with a rule 135 to the time associated with the data item 177 subject to the change 211. For example, for a data item 177 such as a departure time for a train, the rules engine 215 may receive a change 211 to the departure time from 2 pm to 3 pm. The rule 135 associated with the data item 177 may have a time offset that is three hours before the scheduled departure time of the train. Accordingly, the rules engine 215 may subtract the three hour offset from the new departure time for the data item 177 of 3 pm to generate the new time 131 for the alarm 130 of 12 pm (i.e., three hours before the departure time).

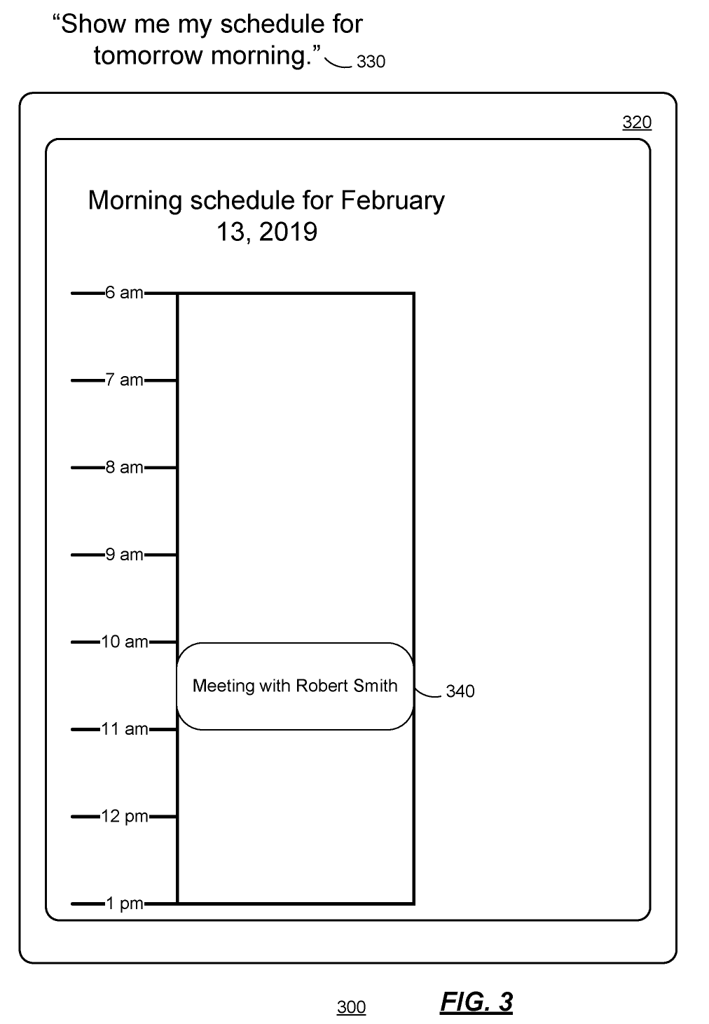

FIG. 3 is an illustration of an example user interface 300 for creating and viewing dynamic alarms 130. The user interface 300 may be implemented by the client device 110 associated with the user. The user interface 300 may be rendered and displayed on a variety of client devices 110 including, but not limited to smartphones, tablet computers, head-mounted displays or headsets, and videogame devices.

As shown in a window 320, a user is presented with a view of a calendar 112 associated with the user. The window 320 may be rendered based on information provided by a calendar application 113 associated with the user. In the example shown at 330, the user has spoken the command “Show me my schedule for tomorrow morning.” In response, the calendar application 113 has displayed the calendar 112 corresponding to the morning of Feb. 13, 2019. The calendar 112 includes an event 340 titled “Meeting with Robert Smith” that is scheduled between 10 am and 11 am.

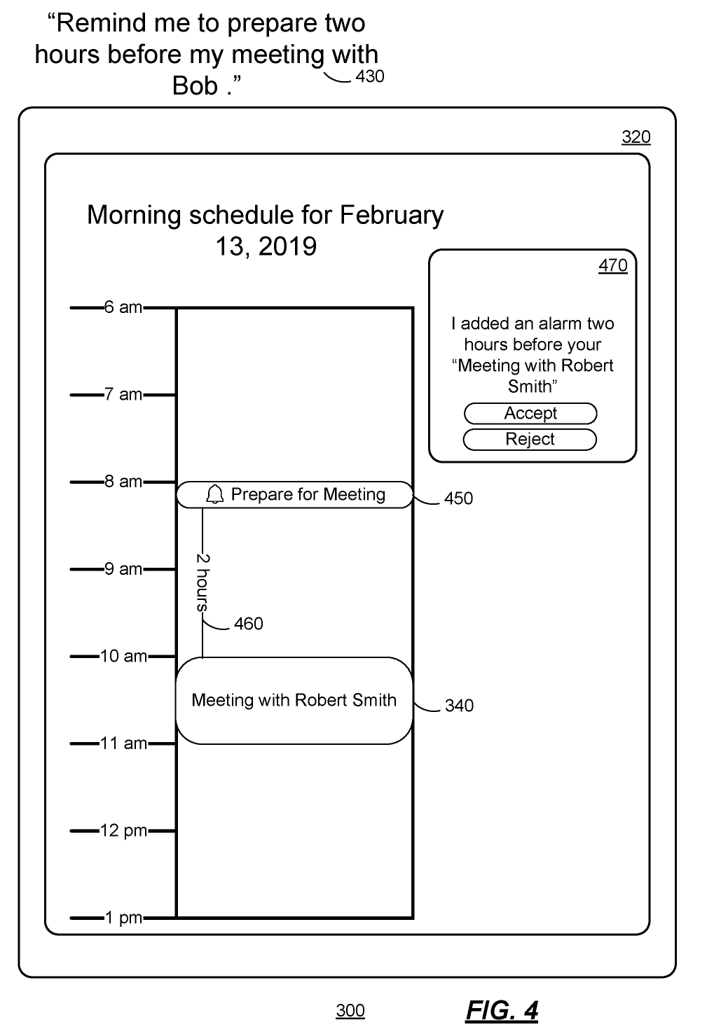

Continuing to FIG. 4, at 430 the user has provided a request 111 for an alarm 130. In the example shown, the user has spoken the request 111 that includes the command “Remind me to prepare two hours before my meeting with Bob.” In response, the request 111 was provided to the alarm generator 205, and the alarm generator 205 processed the request 111 using the alarm model 201 to generate an alarm 130. For example, the alarm engine 205 may have determined, based on the calendar 112 and the alarm model 201, that by “meeting with Bob” the user was likely referring to the “Meeting with Robert Smith” shown as the event 340. The alarm generator 205 may also have determined the rule 135 that the alarm 130 have a time 131 that is two hours before the event 340. The alarm generator 205 may have also interpreted the word “remind” to mean that the user would like to receive a notification as the associated action 133.

Accordingly, the calendar application 113 has displayed an alarm 450 in the window 320 at 8 am (i.e., two hours before the event 340). The alarm 450 includes the text “Prepare for meeting” and a bell icon that is meant to indicate to the user that the action 133 associated with the alarm 130 is to generate a notification.

The calendar application 113 has also displayed graphical indications that inform the user that the alarm 130 is a dynamic alarm 130 that depends on the event 340. In the example shown, a graphic element 460 with the text “2 hours” has been displayed that indicates to the user both that the alarm 450 is dependent on the event 340, and that the alarm 450 is scheduled to occur at a time 131 that is two hours before the event 340.

Also displayed in the window 320 is a window 470 that is used to notify the user that the alarm 450 was added to the calendar 112, and includes user interface elements that the user can use to either “Accept” or “Reject” the alarm 450. In the example shown, the window 470 includes the text “I added an alarm two hours before your ‘Meeting with Robert Smith.’”

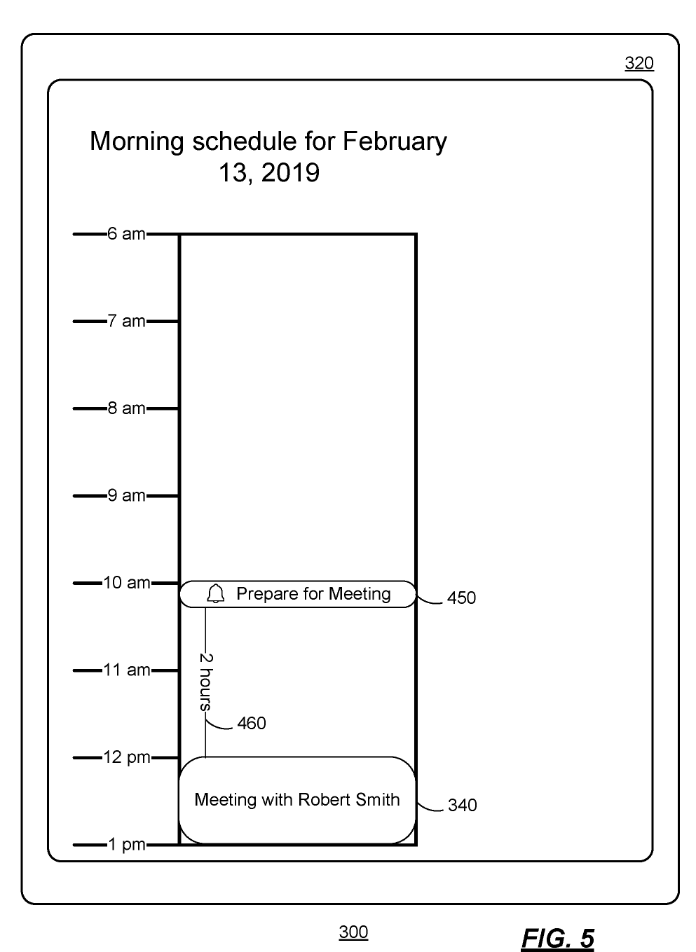

Continuing to FIG. 5, after accepting the alarm 450 there has been a change to the time 131 associated with the event 340. In particular, the “Meeting with Robert Smith” event 340 has been rescheduled to 12 pm. In response, the data engine 210 may have determined the new time, and may have provided a change 211 corresponding to the data item 177 associated with the event 340 to the rules engine 215. The rules engine 215 may have used the rule 135 specifying that the time 131 associated with the alarm 450 is two hours before the event 340, and may have updated the time 131 to 10 am. Accordingly, the calendar applications 113 has redisplayed the alarm 450 at the new time 131.

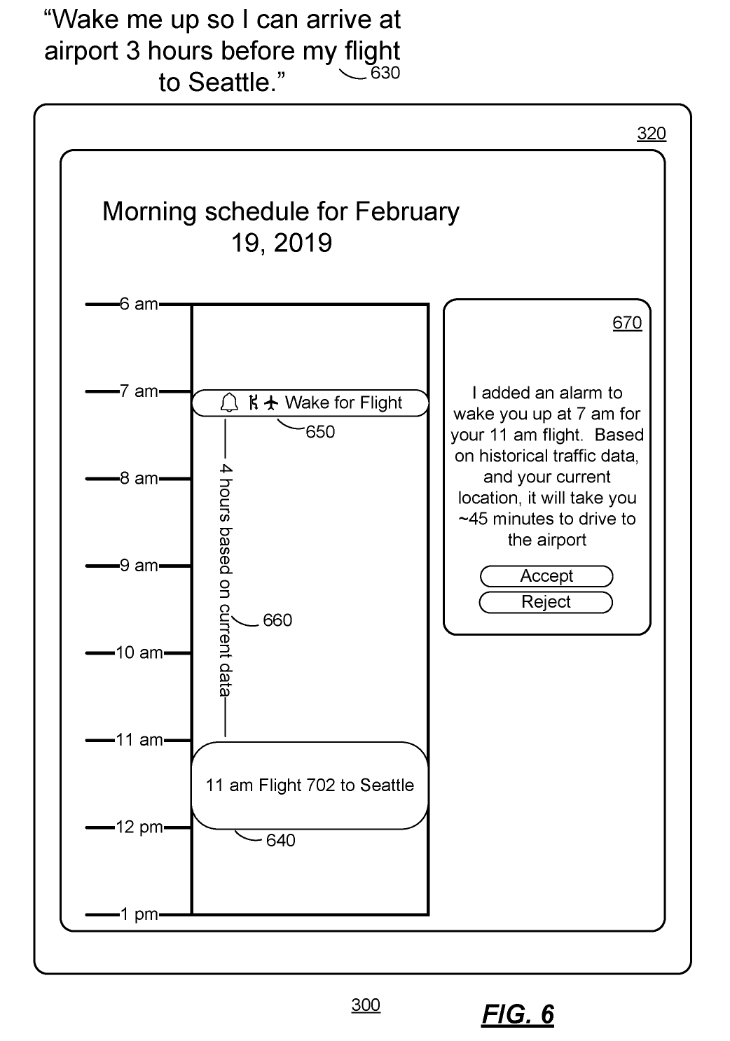

Continuing to FIG. 6, the user has determined to add another alarm 130 to their calendar 112. At 630, the user has spoken the request 111 “Wake me up so I can arrive at the airport three hours before my flight to Seattle.”

In response, the alarm generator 205 has used the alarm model 201 and the calendar 112 to determine that by “my flight to Seattle” the user was likely referring to an event 640 with the text “11 am Flight to Seattle.” For example, the alarm generator 205 may have searched the calendar 112 associated with the user for events that may include or reference flights to Seattle. Where there were multiple matching events the alarm generator 205 have selected a closest event by date and/or time.

The alarm generator 205 has also determined the rule 135 for the alarm 130 is that the user would like to arrive at the airport three hours before the scheduled flight 702 departure. The alarm generator 205 may have further determined that the determined rule 135 depends on several data items 177 including the location of the user, the traffic conditions associated with the location of the user and the airport, and whether or not the scheduled flight is delayed or canceled. The alarm generator 130 may have also interpreted the word “wake” to mean that the user would like to receive a notification as the action 133 for the alarm 130.

Accordingly, the calendar application 113 has displayed an alarm 650 in the calendar 112 at 7 am (i.e., four hours before the event 640). Because the alarm generator 205 cannot know what the actual traffic conditions will be in the future or whether or not the flight will depart on time, initially the time 131 may be estimated based on historical traffic data and/or flight data. The alarm 650 includes the text “Wake for Flight” and a bell icon that is meant to indicate to the user that the action 133 associated with the alarm 650 is to generate a notification.

The calendar application 113 has also displayed graphical indications that inform the user that the alarm 650 is a dynamic alarm that depends on the event 640. In the example shown, a graphic element 660 with the text “four hours based on current data” has been displayed that indicates to the user both that the alarm 650 is dependent on the event 640, and that the alarm 650 is scheduled to occur at a time 131 that is estimated to be four hours before the event 340.

The alarm 650 is also displayed with icons that inform the user of the data items 177 that are associated with the alarm 650. In the example shown, the alarm 650 includes icons of a plane and a map informing the user that the alarm 650 is dependent on data items 177 associated with flight data and traffic data.

Also displayed in the window 320 is a window 670 that is used to notify the user that the alarm 650 was added to the calendar 112, and includes text that explains how the time 131 associated with the alarm 130 was initially estimated based on the historical traffic data and the current location of the user. The window 670 further includes user interface elements that the user can use to either “Accept” or “Reject” the alarm 650.

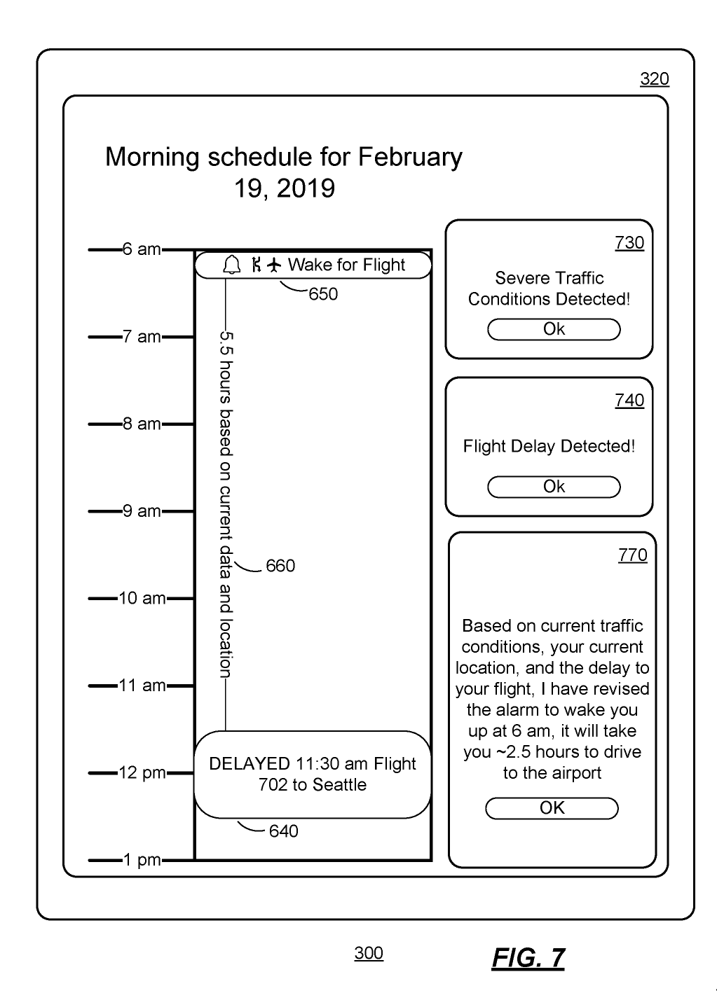

Continuing to FIG. 7, after accepting the alarm 650 the data engine 210 has determined one or more changes 211 with respect to the data items 177 associated with the alarm 650, and the rules engine 215 has applied the rules 135 to the changed data items 177. In the example shown, the data engine 210 has determined that the departure time associated with the flight 702 has been delayed thirty minutes, and that there are severe traffic conditions that may affect how long it takes the user to drive to the airport. A window 730 has been displayed in the window 320 to inform the user of the traffic conditions, and a window 740 has been displayed in the window 320 to inform the user of the flight delay.

Based on the data items 177 and the rule 135 that the user arrive at the airport three hours before the departure time, the rules engine 215 has recalculated the time 131 associated with the alarm 650 and has updated the time 131 in the calendar 112. The graphic element 660 has also been updated to reflect that the alarm 650 now occurs 5.5 hours before the event 640. In addition, a window 770 is displayed in the window 320 that explains to the user how the new time 131 has been calculated to account for the traffic conditions and the flight delay.

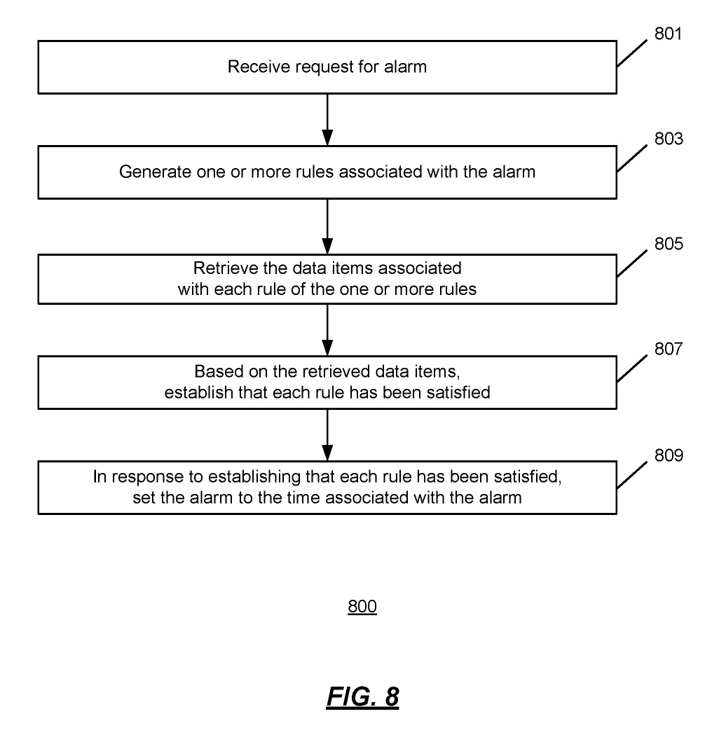

FIG. 8 is an operational flow of an implementation of a method 800 for creating an alarm based on a user request and for dynamically setting a time for the created alarm based on user defined rules and data items. The method 800 may be implemented by one or both of a client device 110 and an alarm engine 165.

At 801, a request for an alarm is received. The request 111 may be received from a calendar application 113 associated with a first user by an alarm generator 205. The request 111 may be a spoken or written request 111. The request 111 may be formatted using natural language, or may be formatted according to a schema, data structure, or programming language.

At 803, one or more rules associated with the alarm are generated from the request. The one or more rules 135 may be generated from the request 111 by the alarm generator 205 using an alarm model 201. The alarm model 201 may be a global alarm model 201, or may be specific to the first user. Each rule 135 may operate on, or may be associated with, one or more data items 177. A rule 135 may include a time offset relative to a time associated with a data item 177 or an event in the calendar of the first user. The data items 177 may include a variety of data such as events from a calendar 112 associated with the first user or a second user, data from external data sources 175 such as, for example, traffic conditions, financial data, sports data, flight or train departure and arrival data, or weather conditions, and location data associated with the first user or the second user.

Depending on the implementation, the alarm generator 205 may further generate an action 133 for the alarm 130 from the request 111. The action 133 associated with the alarm 130 may include sending notifications to one or more users, for example.

At 805, the one or more data items associated with each rule of the one or more rules are retrieved. The data items 177 may be retrieved by the data engine 210 from one or more data sources 175. In some implementations, the data engine 210 may continuously monitor the data items 177 associated with the one or more rules 135, and may receive notice when a change 211 is made to any of the data items 177. In response, the change 211 may be provided by the data engine 210 to the rules engine 215.

At 807, based on the retrieved one or more data items, it is established that each rule of the one or more rules is satisfied. The rules engine 215 may establish that each rule of the one or more rules is established using the retrieved one or more data items 177. In addition, the rules engine 215 may further generate a time 131 associated with the alarm 130 using the one or more rules 135.

At 809, in response to the establishment that each rule of the one or more rules is satisfied, the alarm is set to the time associated with the alarm. The alarm 130 may be set by the calendar application 113 at the client device 110. The calendar application 113 may later perform the action 133 associated with the alarm 130 at the associated time 131 (e.g., generate a notification on the client device 110 associated with the first user).

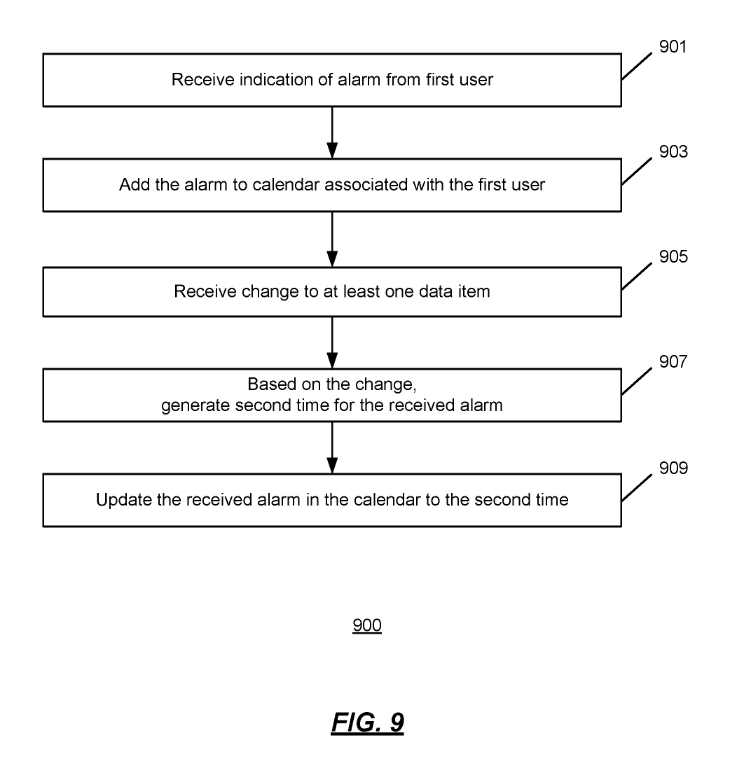

FIG. 9 is an operational flow of an implementation of a method 900 for receiving an alarm and for updating the received alarm in response to changes to one or more data items. The method 900 may be implemented by one or both of a client device 110 and an alarm engine 165.

At 901, an indication of an alarm is received for a first user. The indication of the alarm 130 may be received by the alarm engine 165 and may have been generated by a calendar application 113 associated with the first user. The alarm 130 may have one or more rules 135 that may be used to determine a first time 131 that the alarm 130 may be set to. Each of the rules 135 may operate on one or more data items 177. Each rule 135 may be a time offset with respect to a time associated with a data item 177 of the one or more data items 177.

At 903, the alarm is added to a calendar 112 associated with the first user. The alarm 130 may be added to the calendar 112 by the alarm generator 205 at the first time 131 associated with the alarm 130. Depending on the implementation, the first time 131 may be based on the one or more rules 135 and the one or more data values 177 that the one or more rules 135 operate on.

For example, a rule 135 may have a time offset of fifteen minutes relative to a data item 177 that is the predicted arrival time of a second user based on current traffic conditions. If the predicted arrival time is 7 pm based on the current traffic conditions, then the first time 131 may be set to 7:15 pm by applying the time offset of 15 minutes from the rule 135 to the time of 7 pm associated with the data item 177.

At 905, a change to at least one of the data items is received. The change 211 may be received by the data engine 210. Depending on the implementation, the data engine 210 may receive the change 211 from a data source 175 or by comparing currently received values for the data items 177 with previously received values. The data items 177 associated with the change 211 may be a location of a second user or a time associated with an event in a calendar 112 of the second user.

At 907, based on the change to the at least one data item, a second time is generated for the received alarm. The second time 131 may be generated by the rules engine 215 using the plurality of rules 135 associated with the alarm 130 and the received change 211 to the at least one data item 177.

At 909, the received alarm is updated to the second time. The received alarm 130 may be updated in the calendar 112 associated with the first user by the calendar application 113.

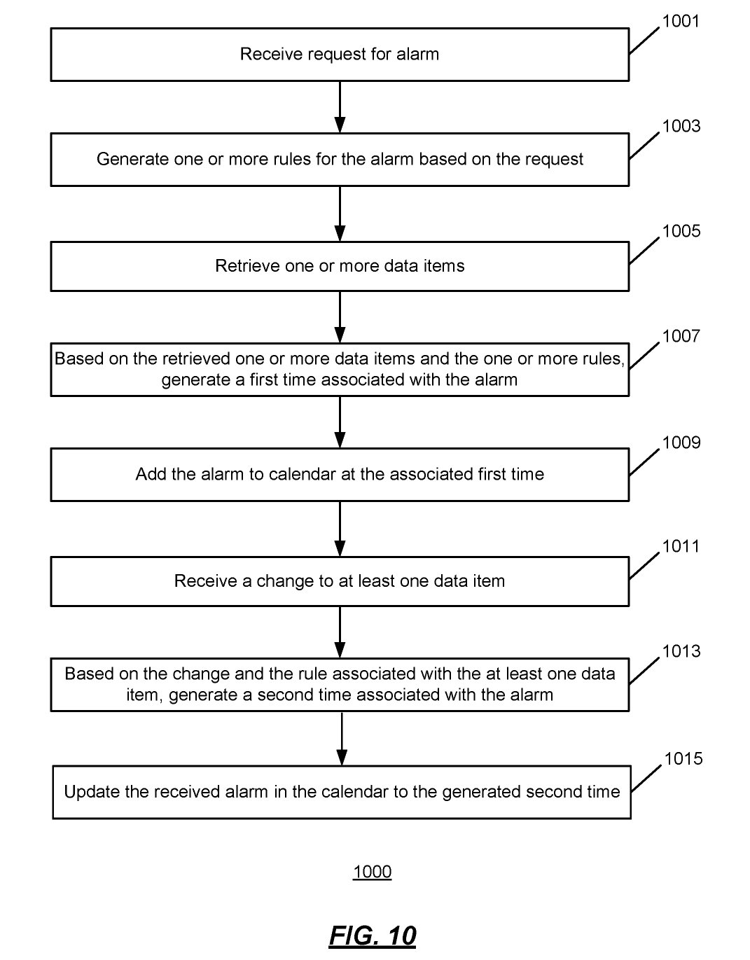

FIG. 10 is an operational flow of an implementation of a method 1000 for generating an alarm and for updating the generated alarm in response to changes to one or more data items. The method 1000 may be implemented by one or both of a client device 110 and an alarm engine 165.

At 1001, a request for an alarm is received. The request 111 may be received from a calendar application 113 associated with a first user by an alarm generator 205.

At 1003, one or more rules associated with the alarm are generated from the request. The alarm generator 205 may generate the one or more rules 135 from the request 111 using an alarm model 201. Each generated rule 135 may operate on or may be associated with one or more data items 177.

At 1005, the data items are retrieved. The data items 177 may be retrieved from one or more data sources 175 by the data engine 210. The retrieved data items 177 may be the data items 177 that are associated with the one or more rules 135. Depending on the implementation, the retrieved data items 177 may include the location of the first user and the location of a second user, or an event in a calendar 112 associated with the first user or the second user.

At 1007, based on the retrieved data items and the one or more rules, a first time associated with the alarm is generated. The first time 131 may be generated by the rules engine 215. For example, the first user may have created an alarm 130 to remind them to prepare two hours before a 9 am meeting with the second user. The rules engine 215 may generate a data item 177 corresponding to the 9 am meeting from the calendars 112 associated with the first and second user, and may apply the time offset of the rule 135 of “two hours before” associated with the alarm 130 to generate a first time 131 of 7 am.

At 1009, the alarm is added to a calendar associated with the first user. The alarm 130 may be added to the calendar 112 associated with the first user by the alarm generator 205 at the first time 131.

At 1011, a change is received to at least one data item. The change 211 to the at least one data item 177 may be received by the data engine 210. In some implementations, the data engine 210 may continuously monitor the data items 177 associated with the plurality of rules 175, and may learn of changes 211 by comparing current values of the data items 177 with previous values of the data items 177. Alternatively, the data engine 210 may subscribe to a stream of data item 177 changes 211 provided by a data source 175 or other service.

Continuing the example above, the second user may move the 9 am meeting to 11 am in their calendar 112. The data engine 210 may monitor the calendar 112 associated with the second user and may receive notice of the change 211 to the corresponding data item 177.

At 1013, based on the change to the at least one data item and the rule associated with the data item 177, a second time associated with the alarm is generated. The second time 113 may be generated by the rules engine 215. Continuing the example above, the rules engine 215 may apply the rule 175 of “two hours before” to the revised data item 177 of 11 am to generate a second time 131 of 9 am.

At 1015, the alarm in the calendar is updated to the generated second time. The alarm 130 may be updated by the alarm generator 205.

FIG. 11 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by the device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a method for managing alarms is provided. The method includes: receiving an indication of an alarm for a first user at a computing device, wherein the alarm is associated with a first time and one or more rules, and each rule is associated with one or more data items; adding the alarm to a calendar associated with the first user at the associated first time by the computing device; receiving a change to at least one data item associated with the one or more of the rules by the computing device; based on the received change and the rule associated with the at least one data item, generating a second time for the alarm by the computing device; and updating the alarm in the calendar to the second time by the computing device.

Implementations may include some or all of the following features. The at least one data item may be an event in the calendar associated with the first user, and the received change may be a change to a time associated with the event in the calendar. The at least one data item may be an event in a calendar associated with a second user, and the received change may be a cancelation of the event. The alarm may be associated with an action, and the method may further include performing the action associated with the alarm for the first user or a second user at the second time. Updating the alarm in the calendar to the second time may further include canceling the alarm. The one or more data items may include one or more of a location of the first user, a location of a second user, a calendar entry associated with the first user, a calendar entry associated with the second user, a weather condition, an asset price, or a traffic condition. The one or more rules may include a time offset to a time associated with the one or more data items.

In an implementation, a method for creating alarms is provided. The method may include: receiving a request for an alarm from a first user by a cloud computing environment; generating one or more rules associated with the alarm from the request by the cloud computing environment, wherein each rule is associated with a data item of one or more data items, and at least one data item of the one or more data items is associated with a second user; retrieving the one or more data items by the cloud computing environment; based on the retrieved one or more data items and the one or more rules, generating a first time associated with the alarm by the cloud computing environment; adding the alarm to a calendar associated with the first user at the associated first time by the cloud computing environment; receiving a change to the at least one data item by the cloud computing environment; based on the change to the at least one data item and the rule associated with the at least one data item, generating a second time associated with the alarm by the cloud computing environment; and updating the received alarm in the calendar associated with the first user to the generated second time by the cloud computing environment.

Implementations may include some or all of the following features. The at least one data item may be an event in a calendar associated with the second user, and the received change may be a change to a time associated with the event in the calendar associated with the second user. The at least one data item may be a location of the second user, and the received change may be a change to the location of the second user. The alarm may be associated with an action and the method may further include performing the action associated with the alarm for the first user or the second user at the second time. The method may further include, based on the received change and the rule associated with the at least one data item, removing the alarm from the calendar associated with the first user. The one or more data items may include one or more of a location of the first user, a location of the second user, a calendar entry associated with the first user, a calendar entry associated with the second user, a weather condition, an asset price, or a traffic condition.

In an implementation, a method for creating an alarm is provided. The method includes: receiving a request for an alarm from a first user by a computing device, wherein the alarm is associated with an action and a time; generating one or more rules associated with the alarm from the request by the computing device, wherein each rule of the one or more rules is associated with a data item; retrieving the data items associated with the one or more rules by the computing device; based on the retrieved data items, establishing that each rule of the plurality of rules has been satisfied; and in response to establishing that each rule of the plurality of rules has been satisfied, setting the alarm to perform the associated action at the associated time.

Implementations may include some or all of the following features. The method may include: establishing that at least one rule of the plurality of rules is not satisfied; and in response to establishing that at least one rule of the plurality of rules is not satisfied, removing the alarm from the calendar associated with the first user. Retrieving the data items associated with the one or more rules may include receiving at least one data item from a second user. The at least one data item may be an entry from a calendar associated with the second user. The method may further include, based on the retrieved data items and the one or more rules, generating the time associated with the alarm. The data items associated with the one or more rules may include one or more a location of the first user, a location of a second user, a calendar entry associated with the first user, a calendar entry associated with the second user, a weather condition, an asset price, a traffic condition, or a transportation condition. The method may further include generating the one or more rules using a machine learning model.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for managing alarms, the method comprising:
receiving an indication of an alarm for a first user at a computing device, wherein the alarm is associated with a first time and one or more rules, and each rule is associated with one or more data items;
adding the alarm to a calendar associated with the first user at the associated first time by the computing device;
receiving a change to at least one data item associated with the one or more of the rules by the computing device;
based on the received change and the rule associated with the at least one data item, generating a second time for the alarm by the computing device; and
updating the alarm in the calendar to the second time by the computing device.

2. The method of claim 1, wherein the at least one data item is an event in the calendar associated with the first user, and the received change is a change to a time associated with the event in the calendar.

3. The method of claim 1, wherein the at least one data item is an event in a calendar associated with a second user, and the received change is cancelation of the event.

4. The method of claim 1, wherein the alarm is associated with an action, and further comprising performing the action associated with the alarm for the first user or a second user at the second time.

5. The method of claim 1, wherein updating the alarm in the calendar to the second time comprises canceling the alarm.

6. The method of claim 1, wherein the one or more data items comprise one or more of a location of the first user, a location of a second user, a calendar entry associated with the first user, a calendar entry associated with the second user, a weather condition, an asset price, or a traffic condition.

7. The method of claim 1, wherein the one or more rules comprises a time offset to a time associated with the one or more data items.

8. A method for creating alarms, the method comprising:
receiving a request for an alarm from a first user by a cloud computing environment;
generating one or more rules associated with the alarm from the request by the cloud computing environment, wherein each rule is associated with a data item of one or more data items, and at least one data item of the one or more data items is associated with a second user;
retrieving the one or more data items by the cloud computing environment;
based on the retrieved one or more data items and the one or more rules, generating a first time associated with the alarm by the cloud computing environment;
adding the alarm to a calendar associated with the first user at the associated first time by the cloud computing environment;
receiving a change to the at least one data item by the cloud computing environment;
based on the change to the at least one data item and the rule associated with the at least one data item, generating a second time associated with the alarm by the cloud computing environment; and
updating the received alarm in the calendar associated with the first user to the generated second time by the cloud computing environment.

9. The method of claim 8, wherein the at least one data item is an event in a calendar associated with the second user, and the received change is a change to a time associated with the event in the calendar associated with the second user.

10. The method of claim 8, wherein the at least one data item is a location of the second user, and the received change is a change to the location of the second user.

11. The method of claim 8, wherein the alarm is associated with an action and further comprising performing the action associated with the alarm for the first user or the second user at the second time.

12. The method of claim 8, further comprising, based on the received change and the rule associated with the at least one data item, removing the alarm from the calendar associated with the first user.

13. The method of claim 8, wherein the one or more data items comprises one or more of a location of the first user, a location of the second user, a calendar entry associated with the first user, a calendar entry associated with the second user, a weather condition, an asset price, or a traffic condition.

14. A method for creating an alarm, the method comprising:
receiving a request for an alarm from a first user by a computing device, wherein the alarm is associated with an action and a time;
generating one or more rules associated with the alarm from the request by the computing device, wherein each rule of the one or more rules is associated with a data item;
retrieving the data items associated with the one or more rules by the computing device;
based on the retrieved data items, establishing that each rule of the plurality of rules has been satisfied; and
in response to establishing that each rule of the plurality of rules has been satisfied, setting the alarm to perform the associated action at the associated time.

15. The method of claim 14, further comprising:
establishing that at least one rule of the plurality of rules is not satisfied; and
in response to establishing that at least one rule of the plurality of rules is not satisfied, removing the alarm from the calendar associated with the first user.

16. The method of claim 14, wherein retrieving the data items associated with the one or more rules comprises receiving at least one data item from a second user.

17. The method of claim 16, wherein the at least one data item is an entry from a calendar associated with the second user.

18. The method of claim 14, further comprising, based on the retrieved data items and the one or more rules, generating the time associated with the alarm.

19. The method of claim 14, wherein the data items associated with the one or more rules comprises one or more a location of the first user, a location of a second user, a calendar entry associated with the first user, a calendar entry associated with the second user, a weather condition, an asset price, a traffic condition, or a transportation condition.

20. The method of claim 14, further comprising generating the one or more rules using a machine learning model.
